(19) United States
(12) Patent Application Publication
(10) Pub. No.: US 2014/0035255 A1
(43) Pub. Date: Feb. 6, 2014

(54) BICYCLE WITH INTERCHANGEABLE FRONT FORK

(71) Applicant: Robert Allen Erickson, Minneapolis, MN (US)

(72) Inventor: Robert Allen Erickson, Minneapolis, MN (US)

(21) Appl. No.: 13/958,707

(22) Filed: Aug. 5, 2013

Related U.S. Application Data
(60) Provisional application No. 61/679,921, filed on Aug. 6, 2012.

(51) Int. Cl. B62K 21/02

(52) U.S. Cl. CPC B62K 21/02
USPC 280/279; 29/897.1

(57) ABSTRACT

A bicycle apparatus with interchangeable front fork is disclosed. The bicycle comprises a frame and a quick release assembly for securing the removable front fork attachment assembly to the bicycle frame's head tube. The interchangeable front fork attachment assembly and quick release assembly allows for the quick interchanging of front fork with varying attachments which utilize different methods to achieve motion.

### CLAIM OF PRIORITY

This application claims the benefit of U.S. Provisional Patent Application Ser. No. 61/679,921, filed on Aug. 6, 2012, the benefit of priority of which is claimed hereby, and which is incorporated by reference herein in its entirety.

### TECHNICAL FIELD

This document generally relates to a multi-purpose type of recreational vehicle equipment, and more particularly, to a multi-purpose bicycle with an interchangeable front assembly such as a fork.

### BACKGROUND

Traditional bicycles generally include two wheel assemblies: one for powering the bicycle and one for steering. Bicycles with various types of wheel assemblies have been designed for use in different situations, environmental conditions, and varying terrain. Typically, these bicycles are designed such that a specific type of wheel assembly can be fixed to the bicycle frame to achieve its intended purpose, which may make the bicycle as a whole specialized for a particular purpose.

Bicycles with fixed type wheel assemblies, or the particular-purpose bicycles, may be limited to use when the environment or road condition is suitable. For example, inclement weather conditions such as snow or ice, which are frequently experienced during the long winter season in northern areas, can substantially limit the utility of the particular-purpose bicycles, thereby reducing their overall value to the users. The users of a particular-purpose bicycle may be forced to own recreational equipment of various types so that they can choose the proper equipment according to the weather conditions and selected terrain. This can be costly and inconvenient to the users. For example, a multitude of recreational vehicles can occupy a large storage space.

Multi-purpose bicycles have been proposed in which the front wheel assembly can be removed from the front fork assembly and replaced with a different assembly such as a ski. Although this approach attempts to address the functional limitations of the bicycles with a specific type of wheel assemblies, the replacement typically requires the user to disassemble the original configuration, and then reconfigure the bicycle for a different use whenever the user wishes variety or the conditions necessitate. The reconfiguration process can be time consuming and may require special tools or skills in order to complete the reconfiguration.

A bicycle with quick release wheel hub assemblies can allow a user to reconfigure the bicycle from a wheel to a different attachment such as a ski without the use of tools. However, the quick release wheel hub assemblies are prone to unintentional wheel release during use, increasing the risk of injury. Therefore, the present inventor has recognized that there remains a considerable need for a multi-purpose bicycle for use in various environmental conditions, and methods for configuring or reconfiguring such a bicycle to other desired forms of recreational equipment with improved efficacy and safety.

### SUMMARY

Various embodiments described herein can help improve the functionality and the ease of use of a multi-purpose bicycle. For example, according to one embodiment of the present document, a vehicle apparatus can comprise a bicycle frame including a head tube, a front fork attachment assembly, a quick release assembly, and a front fork attachment. The quick release assembly can be configured to secure a proximal end of the front fork attachment assembly to an end of the head tube of the bicycle frame. The front fork attachment can be sized, shaped, or configured to secure permanently to the distal end of the front fork attachment assembly. The interchangeable front fork attachment assemblies can securely attach to a plethora of front fork attachment assemblies.

A method of reconfiguring a bicycle can comprise receiving a bicycle with a first detachable front fork attachment assembly attached to a bicycle frame through a head tube of the bicycle frame, where the first front fork attachment assembly can be coupled to a first front fork attachment. The method can include unlocking a quick release assembly, and detaching the first front fork attachment assembly from the bicycle frame when the quick release assembly is unlocked. A second detachable front fork attachment assembly, which is coupled to a second front fork attachment, can be received. The method can include attaching the second front fork attachment assembly to the bicycle frame through the head tube of the bicycle frame, and locking a quick release assembly to allow the reconfigured bicycle to be used in different conditions or environment.

A quick release assembly can be configured for securing a front fork attachment assembly to a head tube of a bicycle. The quick release assembly can include a lever, an attachment clamp coupled to the lever, and an attachment port. The lever can be configured to toggle the attachment clamp between an open and a closed position. The attachment port can be fastened to the attachment clamp. At least a portion of the front fork attachment assembly can be insertable into the attachment port, and the front fork attachment assembly can be secured within the head tube via the attachment clamp.

The above summary of the various aspects and embodiments is not intended to describe each embodiment or every implementation of the bicycle with interchangeable front fork attachment assembly. Rather, the embodiments are chosen and described so that others skilled in the art may appreciate and understand the principles and practices of the bicycle with interchangeable front fork attachment assembly.

### BRIEF DESCRIPTION OF THE DRAWINGS

While the bicycle with interchangeable front fork attachment assembly is amenable to various modifications and alternative forms, specifics thereof have been shown by way of example in the drawings and will be described in detail. Such embodiments are demonstrative and not intended to be exhaustive or exclusive embodiments of the present subject matter.

FIG. 1 is a perspective view of a multi-purpose bicycle with interchangeable front fork, according to some embodiments.

FIG. 2 is a front view of a front fork attachment assembly of the bicycle of FIG. 1.

FIG. 3 is a perspective view of a multi-purpose bicycle with a dual ski front fork attachment assembly.

FIG. 4 is a perspective view of a multi-purpose bicycle with a dual wheel front fork attachment assembly.

FIG. 5 is a perspective view of a multi-purpose bicycle with a raked front fork attachment assembly.

FIGS. 6A-B are perspective views of quick release assemblies and portions of the environment in which the quick release assembly operates, according to some embodiments.

FIG. 7 illustrates an example of a method for reconfiguring the multi-purpose bicycle of FIGS. 1-5.

### DETAILED DESCRIPTION

Disclosed herein is a multi-purpose vehicle, such as a bicycle, for entertainment or general transportation purposes. The bicycle can include a front fork assembly configured to be coupled to a variety of interchangeable front fork attachments. The interchangeable front fork attachments, such as those conditioned for various terrain types or weather conditions, can increase the utility of the bicycle, reduce the need for separate recreational vehicles for separate terrain, and reduce the physical storage space an owner may otherwise need. Although a recreational vehicle such as a recreational bicycle is provided as an example in this document, the apparatus and the methods described herein can be adapted to configure a vehicle to other types of two or multiple wheeled motorized or manually powered vehicles.

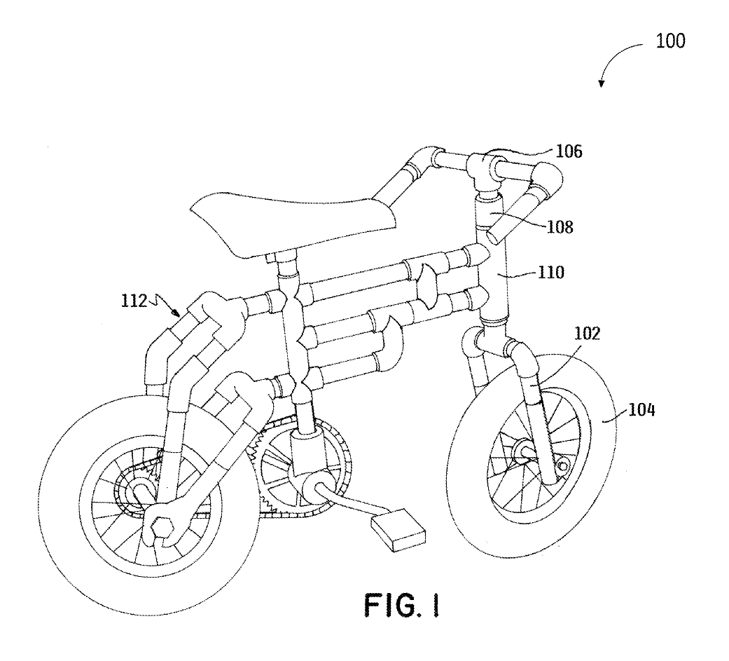

FIG. 1 is a perspective view of a multi-purpose bicycle 100 with interchangeable front fork, according to some embodiments. The bicycle 100 can include a front fork attachment assembly 102, a front fork attachment 104, a handlebar assembly 106, a quick release assembly 108, and a bicycle frame 112. The bicycle frame 112 can include a head tube 110 disposed at the front of the bicycle 100.

The front fork attachment assembly 102 can be secured to the bicycle frame 112 via a quick release assembly 108. The quick release assembly 108 can be mounted directly adjacent to the head tube 110. The head tube 110 can be made as a hollow cylindrical tube and can be permanently fastened to the bicycle frame 112. The head tube 110 can allow a front fork attachment assembly 102 and/or a handlebar assembly 106 to be inserted into or otherwise fastened to the head tube 110, and further secured to the bicycle frame 112 via the quick release assembly 108. The head tube 110 can be constructed from a variety of materials including steel, aluminum, titanium, or other suitable metals, or non-metals which allow a front fork attachment assembly 102 or a handlebar assembly 106 to be reliably secured to the bicycle frame 112.

The front fork attachment assembly 102 can be constructed as a pair of supports, secured to one another. The front fork attachment assembly 102 can be connected at one end to a front fork attachment 104, and at another end be insertable within the head tube 110. In an example, the front fork attachment assembly 102 can include a proximal end and a distal end. The proximal end of the front fork attachment assembly 102 can be sized, shaped, or otherwise configured to be secured to the head tube 110, and thereby secured to the bicycle frame 112. The distal end of the front fork attachment assembly 102 can be sized, shaped, or otherwise configured to be coupled to one of a variety of front fork attachments 104.

The front fork attachment assembly 102 can be made out of a variety of materials including steel, aluminum, titanium, or other suitable metals. The front fork attachment assembly can also be made out of non-metal, synthetic materials such as plastic, polymers, or other materials with desired strength and durability that allow the front fork attachment assembly 102 to reliably support the weight of a user operating the multi-purpose bicycle 100.

A plurality of front fork attachment assemblies 102 and front fork attachments 104 can allow the user to quickly insert and secure the chosen front fork attachment assembly 102 with a desired front fork attachment 104 according to terrain, weather, or other conditions or recreational purposes. Examples of the fork attachment 104 can include a ski, a snowboard, an ice skate, one or multiple wheel assemblies, among others. In some examples, at least a portion of the front fork attachment assembly 102 can be made at a uniform size or shape such that multiple front fork attachment assemblies 102 can be interchangeably attached to or detached from the head tube 110. For example, the front fork attachment assembly 102 can have a uniform size and shape on at least the proximal end of the attachment assembly 102 such that various types of front fork attachment assembly 102 can be securely attached to the distal end of the head tube 110.

In an example, the front fork attachment assembly 102 can be permanently attached to a front fork attachment 104 to form an integrated unit, such that the front fork attachment assembly 102 and the associated front fork attachment 104 can be jointly attached to or detached from the head tube 110. The permanently attached front fork attachment 104 can allow the user to quickly assemble a desired front fork attachment 104 and the front fork attachment assembly 102, or to efficiently replace an existing front fork attachment assembly 102 with another front fork attachment assembly 102 of the same or different type. In another example, the front fork attachment assembly 102 can be configured such that the front fork attachment 104 can be detachable from the front fork attachment assembly 102 and interchanged with another front fork attachment 104. For example, a wheel can be detached from the front fork assembly 102, and a ski can be attached to the same front fork attachment assembly 102 for use in the bicycle 100.

The quick release assembly 108 can be mounted adjacent to a proximal end or a distal end of the head tube 110. The quick release assembly 108 can be constructed in a variety of ways, including but not limited to a push-button coupler joint, cotter key/pin, screw and wing-nut, clamp, or other types of securable connections. The quick release assembly 108 can be configured to secure interchangeable front fork attachment assembly 102 and can allow for the multi-purpose bicycle 100 to be adapted for variable conditions. The quick release assembly 108 can secure a handlebar assembly 106 to the head tube 110, thereby connecting the handlebar assembly 106 to the bicycle frame 112. In an example, the handlebar assembly 106 has at least a portion shaped and configured to be insertable into or otherwise coupled to the proximal end of the head tube 110. The quick release assembly 108 can be configured to secure a user-selected handlebar assembly 106 to the head tube 110, or to detach the handlebar assembly 106 from the head tube 110. The quick release assembly 108 can be configured to secure or release both the front fork attachment assembly 102 and the handlebar assembly 106 to or from the head tube 110 separately or concurrently.

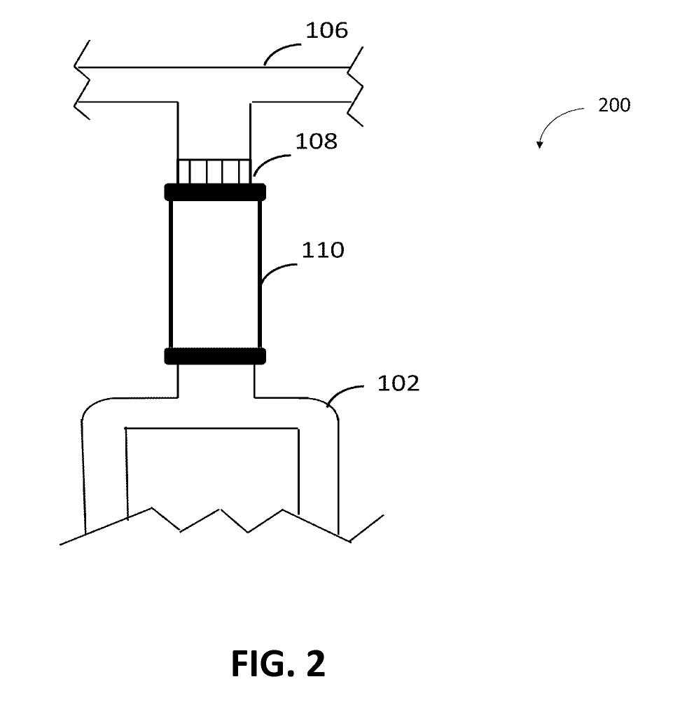

FIG. 2 is a front view of a front fork attachment assembly 102 of the bicycle of FIG. 1. The front fork attachment assembly 102 can be secured to the cylindrical-shaped head tube 110 of the bicycle frame via the quick release assembly 108.

The proximal end of the front fork attachment assembly 102 can be sized, shaped, or otherwise configured to be coupled to at least a portion of the head tube 110. For example, the proximal end of the front fork attachment assembly 102 can have at least a partially cylindrical shape coaxial with the head tube 110, and a diameter smaller than that of the distal end of the head tube 110 to facilitate the insertion of the proximal end of the front fork attachment assembly 102 into the distal end of the head tube 110.

The distal end of the handlebar assembly 106 can be sized, shaped, or otherwise configured to be coupled to at least a portion of the head tube 110. For example, the distal end of the handlebar assembly 106 can have at least a partially cylindrical shape coaxial with the head tube 110, and a diameter smaller than that of the proximal end of the head tube 110 to facilitate the insertion of the distal end of the handlebar assembly 106 into the proximal end of the head tube 110.

As illustrated in FIG. 2, the quick release assembly 108 can be mounted adjacent to the proximal end of the head tube 110. The quick release assembly 108 can be configured to secure the handlebar assembly 106 or the front fork attachment assembly 102 to the head tube 110 through a proximal end or a distal end of the head tube 110, when the handlebar assembly 106 or the front fork attachment assembly 102 is inserted or otherwise coupled to the head tube 110. The quick release assembly 108 can also release the handlebar assembly 106 or the front fork attachment assembly 102 from the head tube 110. In an example, the quick-release assembly 108 can secure or release the handlebar assembly 106 and the front fork attachment assembly 102 separately. In another example, the quick release assembly 108 can secure or release the handlebar assembly 106 and the front fork attachment assembly 102 concurrently.

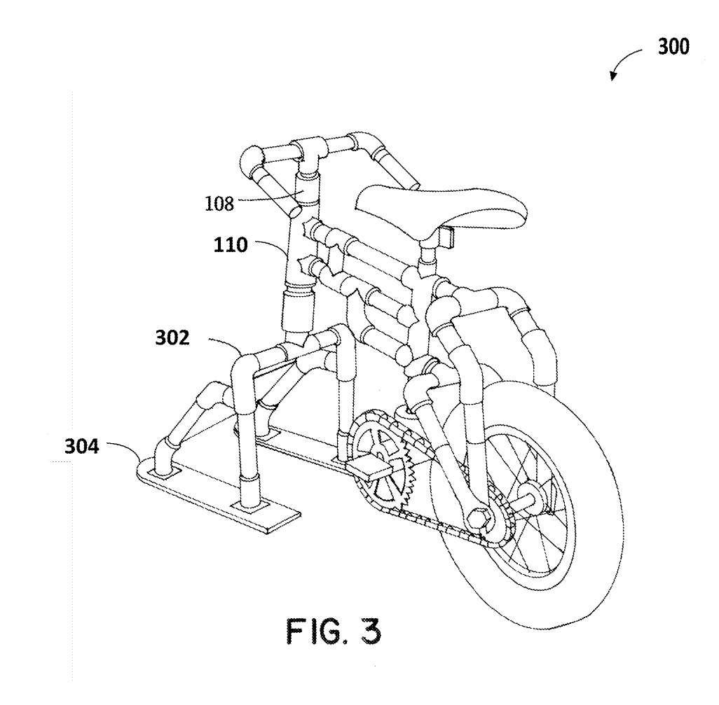

FIG. 3 is a perspective view of a multi-purpose bicycle 300 with a removable front fork attachment assembly 302 and quick release assembly 108. The front fork attachment assembly 302 is coupled to a dual-ski fork attachment 304 which may be used in snow or ice conditions. The front fork attachment assembly 302 includes a proximal end sized, shaped, or otherwise configured to be insertable into a head tube 110 of the bicycle when the front fork attachment assembly 302 or the dual-ski fork attachment 304 is user-adjusted to a desired height or position. The quick release assembly 108 can engage the head tube 110 such as to tightly secure the inserted portion of the front fork attachment assembly 302 within the head tube 110. In an example, the dual-ski fork attachment 304 can be permanently attached to the front fork attachment assembly 302, such that the dual-ski fork attachment 304 and the front fork attachment assembly 302 can be jointly attached to or released from the head tube 110.

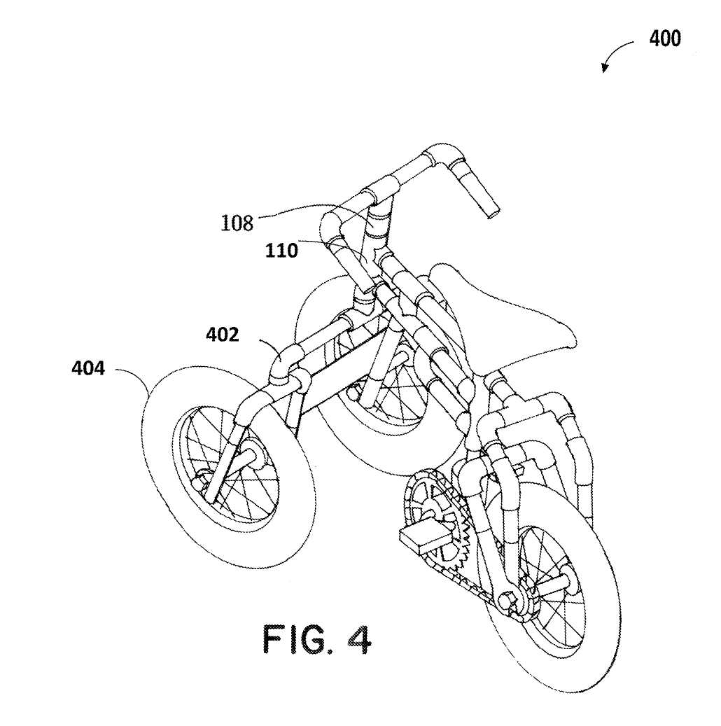

FIG. 4 is a perspective view of a multi-purpose bicycle 400 with a removable front fork attachment assembly 402 and quick release assembly 108. The front fork attachment assembly 402 is coupled to a dual-wheel fork attachment 404 which may be used in various road conditions or terrain such as for enhanced stability. The front fork attachment assembly 402 includes a proximal end sized, shaped, or otherwise configured to be insertable into the head tube 110 of the bicycle when the front fork attachment assembly 402 or the dual-wheel fork attachment 404 is user-adjusted to a desired height or position, such as to level with the rear wheel of the multi-purpose bicycle 400. The quick release assembly 108 can engage the head tube 110 to tightly secure the inserted portion of the front fork attachment assembly 402 within the head tube 110. The dual-wheel fork attachment 404 can be permanently attached to the front fork attachment assembly 402, such that the dual-wheel fork attachment 404 and the front fork attachment assembly 402 can be jointly attached to or released from the head tube 110.

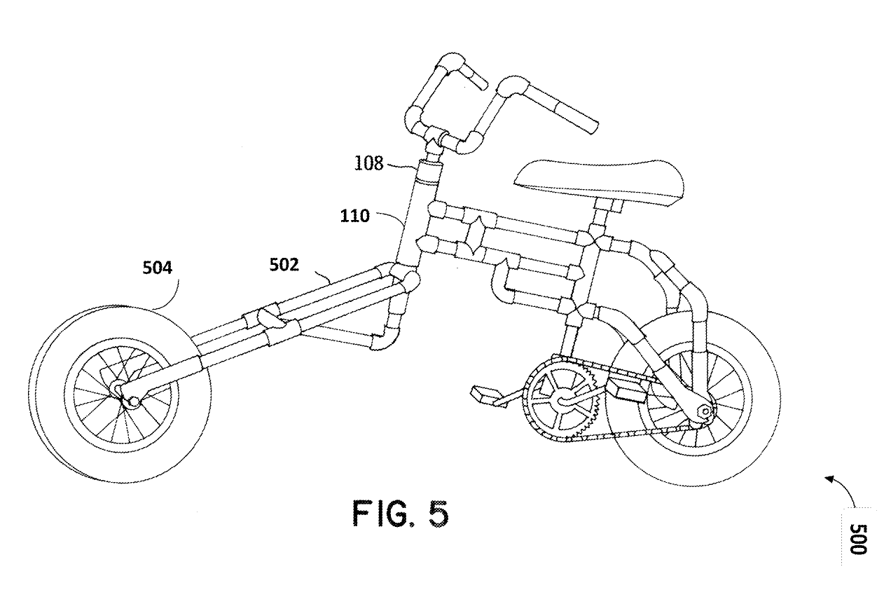

FIG. 5 is a perspective view of a multi-purpose bicycle of 500 with removable front fork attachment assembly 502 and quick release assembly 108. The front fork attachment assembly 502 is raked which may be used in various conditions such as for recreational sports. The front fork attachment assembly 502 includes a proximal end sized, shaped, or otherwise configured to be insertable into the head tube 110 of the bicycle when the front fork attachment assembly 502 or the attached raked front wheel fork attachment 504 is user-adjusted to a desired height or position, such as to level with the rear wheel of the multi-purpose bicycle 500. The quick release assembly 108 can engage the head tube 110 such as to tightly secure the inserted portion of the front fork attachment assembly 502 within the head tube 110. The raked front wheel fork attachment 504 can be permanently attached to the front fork attachment assembly 502, such that the raked front wheel fork attachment 504 and the front fork attachment assembly 502 can be jointly attached to or released from the head tube 110.

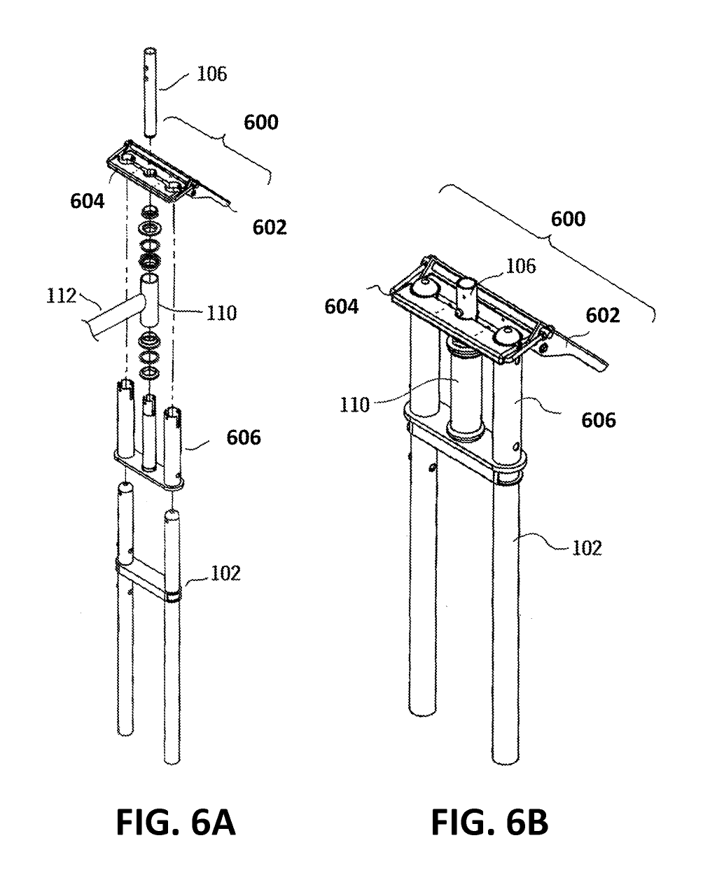

FIGS. 6A-B are perspective views of a quick release assembly 600 and portions of the environment in which the quick release assembly 600 operates, according to some embodiments. The quick release assembly 600 is an example of the quick release assembly 108. Therefore, the quick release assembly 600 can be used in any of multi-purpose bicycles as shown in FIGS. 1, 3, 4, and 5.

FIG. 6A illustrates various components and the configuration of the quick release assembly 600, and FIG. 6B is a perspective view of the assembled quick release assembly 600. The quick release assembly 600 may include a lever 602, an attachment clamp 604 coupled to the lever 602, and an attachment port 606. The lever 602 can be configured to toggle the attachment clamp 604 between an open and a closed position. As illustrated in FIG. 6A, when the lever 602 toggles the attachment clamp 604 to the close position, the attachment clamp 604 can secure the front fork attachment assembly 102 through a portion of the front fork attachment assembly 102 inserted within the attachment port 606. The attachment port 606 can have multiple port compartments each sized, shaped, or otherwise configured to accommodate a respective attachment such as the front fork attachment assembly 102 and the handlebar assembly 106.

As illustrated in FIGS. 2A and 2B, the attachment port 606 can include three linearly arranged port compartments parallel to each other. The two outer port compartments can allow for insertion by the two supports of the front fork attachment assembly 102, and the center port compartment can allow for insertion by the handlebar assembly 106 through the head tube 110.

The closing of the attachment clamp 604 can secure the handlebar assembly 106 through a partially inserted portion within the attachment port 606. In some examples, the attachment port 606 can be configured to allow for both the handlebar assembly 106 and the front fork attachment assembly 102 to be simultaneously secured to the bicycle frame 112.

At least a portion of the attachment port 606 can be inserted into the head tube 110. For example, the attachment port 606 can include a cylindrical portion coaxial with the head tube 110, where the cylindrical portion of the attachment port 606 can have a diameter smaller than that of the head tube 110 such as to facilitate the insertion of the attachment port into the head tube. The respective coupling portions of the attachment port 606 and the head tube 110 can include mechanisms configured to allow for the handlebar assembly 106 to be rotated freely within the head tube 110. For example, the respective coupling portions of the attachment port 606 and the head tube 110 can be coupled to one or more bearings such as ball bearings, roller bearings, or other bearings, or be processed with lubrication including bearing grease.

The quick release assembly 600 can include a confirmation mechanism providing feedback to the user about the attachment or detachment between the front fork attachment assembly 102 and the attachment port 606. The confirmation mechanism can include visual, audio, audio-visual, or other types of confirmation mechanisms. In an example, the quick release assembly 600 may include an indicator invisible when the front fork attachment assembly 102 is not properly inserted. The indicator pops up on or around the outer surface of the quick release assembly 600 and becomes visible to the user only when the front fork attachment assembly 102 is properly inserted. In an example, the indicator, when popping up, can generate a audible sound alerting the user the proper insertion. Same or similar visual or audio confirmation mechanisms can be used to indicate that the handlebar assembly 106 is properly inserted and secured within the attachment port 606.

The quick release assembly 600 can be constructed from a variety of materials including steel, aluminum, titanium, or other suitable metals, or non-metals which allow the quick release assembly 600 to reliably secure the front fork attachment assembly 102 and or the handlebar assembly 106 to the bicycle frame 112.

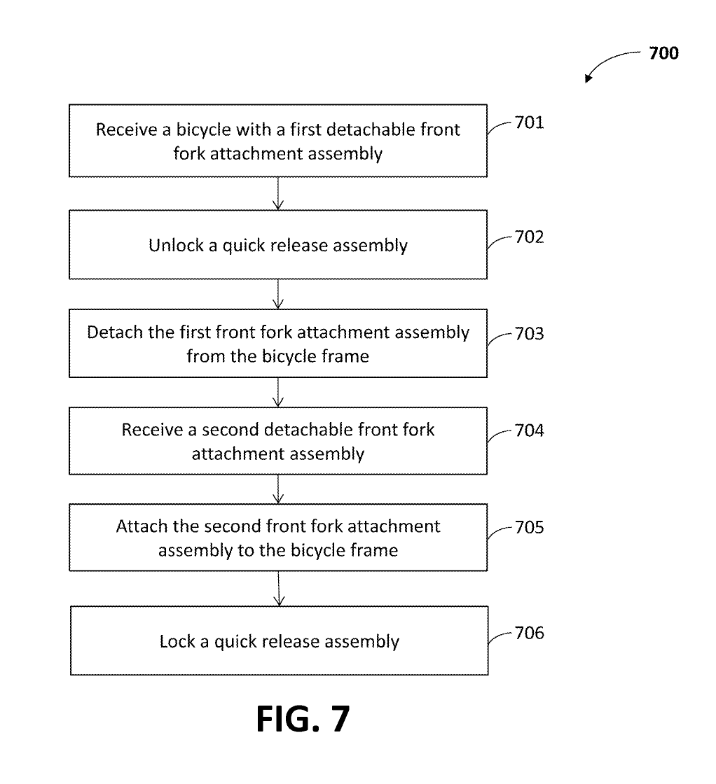

FIG. 7 illustrates an example of a method 700 for reconfiguring a multi-purpose bicycle. The method 700 can be used in assembling a multi-purpose bicycle with interchangeable front fork attachment assembly such as one of the multi-purpose bicycles 100, 300, 400 or 500 and the several fork attachments, as illustrated in FIGS. 1-5.

At 701, a bicycle with a first detachable front fork attachment assembly is obtained, received or otherwise available. The bicycle, such as one of the multi-purpose bicycles 100, 300, 400 or 500, can include a quick release assembly that can tightly secure the first front fork attachment assembly to the bicycle frame such as through a head tube. In an example, the head tube can have a hollow cylindrical shape that accommodates at least a portion of the first front fork attachment assembly insertable into the head tube. The first front fork attachment assembly can include and may be permanently coupled to a front fork attachment such as a ski, a snowboard, an ice skate, one or more wheels, or other fork attachments.

At 702, the quick release assembly can be unlocked such as to allow the secured first front fork attachment assembly to be removable from the bicycle frame. The quick release assembly can include one or more of securable connections such as a push-button coupler joint, a cotter key or pin, a screw, or a wing-nut. The quick release assembly can be manually adjusted to either a lock position or an unlock position. When setting to the unlock position, the quick release assembly can disengage at least the portion of the first front fork attachment assembly from the head tube of the bicycle. For example, unlocking the quick release assembly can release the proximal end of the first front fork attachment assembly from the head tube of the bicycle.

The first front fork attachment assembly can be detached from the bicycle frame at 703 when the quick release assembly is unlocked. For example, the inserted portion of the first front fork attachment assembly can be removed from the distal end of the head tube. The front fork attachment associated with the first front fork attachment assembly can also be detached from the bicycle.

At 704, a second detachable front fork attachment assembly may be selected, received or otherwise available. The second front fork attachment assembly can include and/or be coupled to a second front fork attachment such as a ski, a snowboard, an ice skate, one or more wheel assembly, among others. The second front fork attachment assembly can be of a different type than the first front fork attachment assembly, and may be adapted to be used in a condition or environment different than what the first front fork attachment assembly is used for, or for a different recreational activity as a user may choose. In an example, the second front fork attachment assembly can be of a same or similar type as the first front fork attachment assembly, such as to replace a malfunctioned or defected first front fork attachment assembly and use the bicycle in a manner or under conditions similar to that where the first front fork attachment assembly is used.

At 705, the second front fork attachment assembly can be attached to the bicycle frame such as through an end of the head tube from which the first front fork attachment assembly is detached. For example, the proximal end of the second front fork attachment assembly can have at least a partially cylindrical shape coaxial with the head tube, and a diameter smaller than that of the distal end of the head tube such as to facilitate the insertion of the proximal end of the second front fork attachment assembly into the distal end of the head tube.

At 706, the quick release assembly can be locked such as to allow the inserted portion of the second front fork attachment assembly to be tightly secured within the head tube of the bicycle. The one or more securable connections within the quick release assembly can be manually adjusted to a lock position, and the quick release assembly can engage at least the portion of the second front fork attachment assembly to the head tube of the bicycle.

In an example, the quick release assembly can comprise a lever, an attachment clamp coupled to the lever, wherein the lever is configured to toggle the attachment clamp between an open and a closed position, and an attachment port fastened to the attachment clamp wherein at least a portion of the front fork attachment assembly is insertable into the attachment port, wherein the front fork attachment assembly is securable within the head tube via the attachment clamp.

In an example, a handlebar assembly can be insertable into the attachment port and wherein the handlebar assembly is securable within the attachment port via the attachment clamp.

In an example, the quick release assembly can be made of metal selected from a group consisting of steel, aluminum, and titanium.

In an example, the quick release assembly can be configured to display at least one of a visual confirmation or an audio confirmation of the front fork attachment assembly inserted and secured within the attachment port.

In an example, the quick release assembly can be configured to display at least one of a visual confirmation or an audio confirmation of the handlebar assembly inserted and secured within the attachment port.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A vehicle apparatus comprising:
a bicycle frame including a head tube, wherein the head tube includes a proximal end and a distal end;
a front fork attachment assembly, including a proximal end and a distal end;
a quick release assembly configured to secure the front fork attachment assembly to the head tube; and
a front fork attachment configured to be coupled to the front fork attachment assembly.

2. The apparatus of claim 1, wherein:
proximal end of the front fork attachment assembly is sized, shaped, or otherwise configured to be secured to the head tube; and
the distal end of the front fork attachment assembly is sized, shaped, or otherwise configured to be coupled to one of a variety of front fork attachment.

3. The apparatus of claim 1, wherein the quick release assembly is configured to secure the proximal end of the front fork attachment assembly to the proximal end of the head tube.

4. The apparatus of claim 1, wherein the quick release assembly is configured to secure the proximal end of the front fork attachment assembly to the distal end of the head tube.

5. The apparatus of claim 1, wherein the quick release assembly is configured to detach the front fork attachment assembly from the head tube.

6. The apparatus of claim 1, further including a handlebar assembly, wherein the quick release assembly is further configured to secure the handlebar assembly to the head tube.

7. The apparatus of claim 6, wherein the quick release assembly is configured to detach the handlebar assembly to the head tube.

8. The apparatus of claim 6, wherein the quick release assembly is configured to concurrently attach the handlebar assembly and the front fork attachment assembly to the head tube when the quick release assembly is set to a lock position; and to concurrently detach the handlebar assembly and the front fork attachment assembly from the head tube when the quick release assembly is set to an unlock position.

9. The apparatus of claim 6, wherein the quick release assembly includes one or more of a coupling mechanisms including a push-button coupler joint, a cotter key or pin, a screw, or a wing-nut.

10. The apparatus of claim 1, wherein the front fork attachment is configured to be permanently attached to the front for attachment assembly.

11. The apparatus of claim 1 wherein the front fork attachment includes a ski.

12. The apparatus of claim 1 wherein the front fork attachment includes a one or multiple wheel assembly.

13. The apparatus of claim 1 wherein the front fork attachment includes an ice skate.

14. The apparatus of claim 1 wherein the front fork attachment includes a snow board.

15. A method of reconfiguring a bicycle, comprising:
receiving a bicycle with a first detachable front fork attachment assembly attached to a bicycle frame through a head tube of the bicycle frame, the first front fork attachment assembly coupled to a first front fork attachment;
unlocking a quick release assembly;
detaching the first front fork attachment assembly from the bicycle frame when the quick release assembly is unlocked;
receiving a second detachable front fork attachment assembly, the second front fork attachment assembly coupled to a second front fork attachment;
attaching the second front fork attachment assembly to the bicycle frame through the head tube of the bicycle frame; and
locking a quick release assembly.

16. The method of claim 15, wherein detaching the first front fork attachment includes removing the first front fork attachment assembly from at least one of a proximal end or a distal end of the head tube.

17. The method of claim 15, wherein attaching the second front fork attachment assembly includes inserting the second front fork attachment assembly to at least one of a proximal end or a distal end of the head tube.

18. The method of claim 15, wherein receiving the second front fork attachment assembly includes receiving a front fork attachment assembly of identical type as the first front fork attachment assembly.

19. The method of claim 15, wherein receiving the second front fork attachment assembly includes receiving a front fork attachment assembly of different type than the first front fork attachment assembly.

20. The method of claim 15, wherein receiving the first front fork attachment assembly and receiving the second front fork attachment assembly each includes receiving a front fork attachment assembly permanently attached to one of a ski, an ice skate, a snow board, or one or more wheel assembly.
